(19) United States
(12) Patent Application Publication
(10) Pub. No.: US 2025/0217502 A1
(43) Pub. Date: Jul. 3, 2025

(54) SHARING METHOD FOR CONTENT SPACE, ELECTRONIC DEVICE, AND STORAGE MEDIUM

(71) Applicant: Beijing Zitiao Network Technology Co., Ltd., Beijing (CN)

(72) Inventor: Guozhou JIANG, Beijing (CN)

(21) Appl. No.: 18/996,636

(22) PCT Filed: Jul. 19, 2023
(86) PCT No.: PCT/CN2023/108021

§ 371 Date: Jan. 17, 2025

(30) Foreign Application Priority Data
Jul. 21, 2022 (CN) 202210863688.0

(51) Int. Cl. G06F 21/62; G06F 21/31

(52) U.S. Cl. CPC G06F 21/6209; G06F 21/31

(57) ABSTRACT

A sharing method for a content space, an electronic device and storage medium are provided. The sharing method for a content space includes: in response to an opening operation for a target content space, displaying the target content space, wherein the target content space includes at least one page with a belonging relationship; in response to changing a first sharing permission of the target content space to a first permission, adjusting a second sharing permission of the page to a second permission based on the belonging relationship and the first permission; and in response to receiving an access request to the target content space with the first permission, providing the page with the second permission for accessing.

This application claims the priority to and benefits of Chinese Patent Application No. 202210863688.0, filed on Jul. 21, 2022, the entire contents of which are incorporated herein by reference.

### TECHNICAL FIELD

Embodiments of the present disclosure relate to a sharing method for a content space, an apparatus, an electronic device, and a storage medium.

### BACKGROUND

Content spaces are different categories of knowledge systems constructed by users according to needs, which includes a plurality of pages with belonging relationships. In order to achieve the sharing of the content space, it is generally necessary to share the content space constructed. For example, for a product A, in order to facilitate the users to quickly understand the product A, developers of the product A may usually construct a content space for the product A and share it with the users. Based on this, it involves a sharing problem of the content space.

### SUMMARY

In view of this, embodiments of the present disclosure provide a sharing method for a content space, an apparatus, an electronic device, and a storage medium, as to solve the sharing problem of the content space.

According to a first aspect, embodiments of the present disclosure provides a sharing method for a content space, which includes:
in response to an opening operation for a target content space, displaying the target content space, wherein the target content space comprises at least one page with a belonging relationship;
in response to changing a first sharing permission of the target content space to a first permission, adjusting a second sharing permission of the page to a second permission based on the belonging relationship and the first permission; and
in response to receiving an access request to the target content space with the first permission, providing the page with the second permission for accessing.

According to a second aspect, embodiments of the present disclosure provides a sharing apparatus for a content space, which includes:
a first response module, used to in response to an opening operation for a target content space, display the target content space, wherein the target content space comprises at least one page with a belonging relationship;
a second response module, used to in response to changing a first sharing permission of the target content space to a first permission, adjust a second sharing permission of the page to a second permission based on the belonging relationship and the first permission; and
a third response module, used to in response to receiving an access request to the target content space with the first permission, provide the page with the second permission for accessing.

According to a third aspect, embodiments of the present disclosure provides an electronic device, which includes: a memory and a processor, wherein the memory and the processor are connected to each other in communication, a computer instruction is stored in the memory, and the processor executes the sharing method described in the first aspect or any one of the implementations of the first aspect.

According to a third aspect, embodiments of the present disclosure provides a computer-readable storage medium, wherein the computer-readable storage medium stores a computer instruction, and the computer instruction is used to enable a computer to execute the sharing method described in the first aspect or any one of the implementations of the first aspect.

The sharing method for the content space provided in the embodiment of the present disclosure, when a target content space is shared, sets sharing permissions for the target content space and pages in the target content space respectively, so that when the entire target content space is shared externally, the sharing permissions may be set for various pages in the target content space respectively; at the same time, when the sharing permission is set on the page, it is based on an belonging relationship of the page, the sharing permission of a father page may affect the sharing permission of a child page, thereby the data processing volume of adjusting a second sharing permission of the page is reduced, and the efficiency of content space sharing is improved.

### BRIEF DESCRIPTION OF DRAWINGS

In order to describe specific implementations of the present disclosure more clearly, drawings required in the specific implementation modes are briefly introduced below. Apparently, the drawings in the following description are some of the implementation modes of the present disclosure. For those of ordinary skill in the art, other drawings may also be obtained according to these drawings without paying creative labor.

FIG. 1 is a flow diagram of a sharing method for a content space according to an embodiment of the present disclosure;

FIG. 2 is a schematic diagram of the content space according to an embodiment of the present disclosure;

FIGS. 3a-3b are schematic diagrams of sharing interfaces of the content space according to an embodiment of the present disclosure;

FIG. 4 is a flow diagram of a sharing method for a content space according to an embodiment of the present disclosure;

FIG. 5 is a schematic diagram of the content space according to an embodiment of the present disclosure;

FIG. 6 is a flow diagram of a sharing method for a content space according to an embodiment of the present disclosure;

FIG. 7a-7b are schematic diagrams of display interfaces of the content space according to an embodiment of the present disclosure;

FIG. 8 is a structure block diagram of a sharing apparatus for a content space according to an embodiment of the present disclosure; and

FIG. 9 is a schematic diagram of a hardware structure of an electronic device provided in an embodiment of the present disclosure.

### DETAILED DESCRIPTION

In order to make purposes, technical schemes, and advantages of embodiments of the present disclosure clearer, the technical schemes in the embodiments of the present disclosure are clearly and completely described below in combination with drawings in the embodiments of the present disclosure. Apparently, the embodiments described are a part of the embodiments of the present disclosure, not all of the embodiments. Based on the embodiments of the present disclosure, all other embodiments obtained by those skilled in the art without paying creative labor shall fall within the scope of protection of the present disclosure.

When a content space is shared, it is first to construct the content space, then generate an access link, and share the access link with a user. The user may access the content space by the access link. However, since a plurality of pages is included in the content space, some of the pages may be shared, while some of the pages may not be shared. Based on this, in order to guarantee the security of non-shareable pages, it is usually necessary to display these non-shareable pages in an additional content space, this may cause the pages that originally belong to the same content space to be split into two independent content spaces, so that the association between the pages is relatively low, and when a manager maintains the content spaces, it needs to switch between the two independent content spaces, so that the maintenance efficiency is relatively low.

Based on this, a sharing method for a content space provided in an embodiment of the present disclosure integrally shares a target content space, and independently sets a sharing permission for each page. Namely, after a first sharing permission of the target content space is adjusted to a first permission, it is equivalent to integrally sharing the target content space; at the same time, a second sharing permission of the page is adjusted based on the first permission and an belonging relationship between the pages, to achieve the independent adjustment of the second sharing permission of the page, and when the second sharing permission of the page is adjusted, it is combined with the belonging relationship of the page, to guarantee the association adjustment between the pages. By using this method, it may be achieved that when the target content space is integrally shared, the sharing permission is independently set for each page, the association correlation between the pages is guaranteed, and the manager only needs to maintain one target content space to maintain the shareable and non-shareable pages without switching between the content spaces, thus the maintenance efficiency of the content space is improved.

In some implementations, when the target content space is shared, an access link to the target content space is generated, and the access link may be opened by a webpage or other applications. For example, the target content space is constructed based on an application A, after an access link is generated, an instant message delivery function of an application B is used to share the access link, and the user may directly click on the access link in the application B to access the target content space.

According to the embodiments of the present disclosure, a sharing method for a content space is provided. It should be noted that steps shown in the flow diagrams of the drawings may be executed in a computer system such as a group of computer executable instructions, and although the logical order is shown in the flow diagram, in some situations, the steps shown or described may be executed in a different order than here.

In this embodiment, a sharing method for a content space is provided, which may be used for the above electronic device, such as a user terminal or a server. FIG. 1 is a flow diagram of a sharing method for a content space according to an embodiment of the present disclosure, as shown in FIG. 1, the flow includes the following steps:

S11, in response to an opening operation for a target content space, the target content space is displayed.

Herein, the target content space includes at least one page with a belonging relationship.

In some implementation modes, the at least one page with the belonging relationship may be stored in the form of a multiway tree, a linked list, or a data table. Based on this, the storage mode of the target content space includes but not limited to the multiway tree, the linked list, or the data table, and its specific storage mode is not limited here, as long as the corresponding storage mode may represent the belonging relationship between at least one page. Herein, the belonging relationship is used to represent a relationship between a page and a child page. For example, for a page A, it includes a page B and a page C. Therefore, the page B and the page C belong to the page A, or the page B and the page C may also be referred to as child pages of the page A.

In some implementations, the content space may be a database or a document library, and the page in the content space may be a table page that carries content or data, or a document page that carries content or data.

In some implementation modes, the target content space may be stored in the electronic device, and the electronic device includes but not limited to the user terminal or the server. When it is necessary to share the target content space, a sharing interface of the target content space is displayed. On the sharing interface, a sharing switch or tag or the like may be set. The user may implement the opening operation by selecting the corresponding switch or tag. The user opens the sharing of the target content space by the selection interaction with the sharing interface. Correspondingly, in response to the opening operation, it may determine which target content space is currently shared.

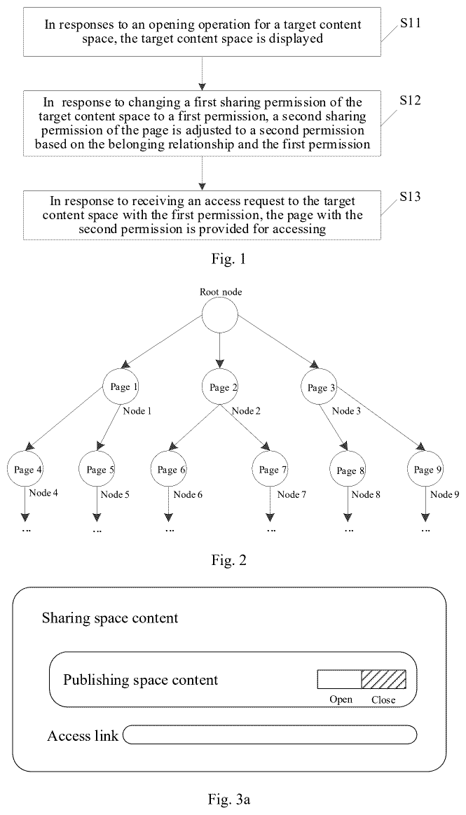

In some implementations, the target content space is stored in the form of the multiway tree, a root node of the multiway tree is a root node of the target content space, and a relationship between nodes of the multiway tree corresponds to the belonging relationship. As shown in FIG. 2, the root node of the multiway tree is the root node of the target content space, the pages included in the target content space are the nodes of the multiway tree, and the connection relationship between the nodes represents the belonging relationship between the pages. For example, a page 1 corresponds to a node 1, a page 4 corresponds to a node 4, a page 5 corresponds to a node 5, the node 4 and the node 5 are child nodes of the node 1, and correspondingly, the page 4 and the page 5 belong to the page 1. The node 1 and the node 4 belong to the same branch, and the node 1 and the node 5 belong to the same branch. The form of the multiway tree is used to represent the target content space, which may clearly and intuitively represent the belonging relationship between the pages.

S12, in response to changing a first sharing permission of the target content space to a first permission, a second sharing permission of the page is adjusted to a second permission based on the belonging relationship and the first permission.

In some implementations, in response to the opening operation for the target content space, the first sharing permission of the target content space is adjusted to the first permission, namely the sharing of the target content space is opened, so that the target content space provides integral external sharing. After the first sharing permission is adjusted to the first permission, the second sharing permission of the page is adjusted by a mode of permission extension, and the belonging relationship of the page is combined during the permission extension. The belonging relationship is used, to analyze the pages belonging to the same link, and then analyze the second sharing permission on the pages belonging to the same link. The second sharing permission of the upper page affects the second sharing permission of the lower page.

In some implementations, the belonging relationship represents an ownership between the pages, and from the perspective of the second sharing permission, if the upper page is not shareable, the page belonging to the upper page is also not shareable. Based on this, the belonging relationship is used to firstly query the upper page that is not shareable, and then the second sharing permission of all pages belonging to the upper page is determined as non-shareable.

In some implementation modes, the second sharing permission of the upper page is not limited to the non-shareable as described above, but may also be readable by personnel in the organization, editable by personnel in the organization and the like. There are no any restrictions on it here, and it is specifically set according to actual needs. It is only guaranteed that during the permission extension, it is necessary to combine the belonging relationship of the page, so that for each page, the second sharing permission may be accurately adjusted to the second permission.

S13, in response to receiving an access request to the target content space with the first permission, the page with the second permission is provided for accessing.

In some implementation modes, after the second sharing permission of the page is adjusted, the sharing of the target content space may be achieved. As described above, the user interacts with the electronic device, to generate a sharing link for the target content space, and the user shares the sharing link, the sharing of the target content space may be achieved. When the sharing link is shared, the sharing link may be directly copied, or a link may be used to share with other applications or the like, it is specifically set according to actual needs.

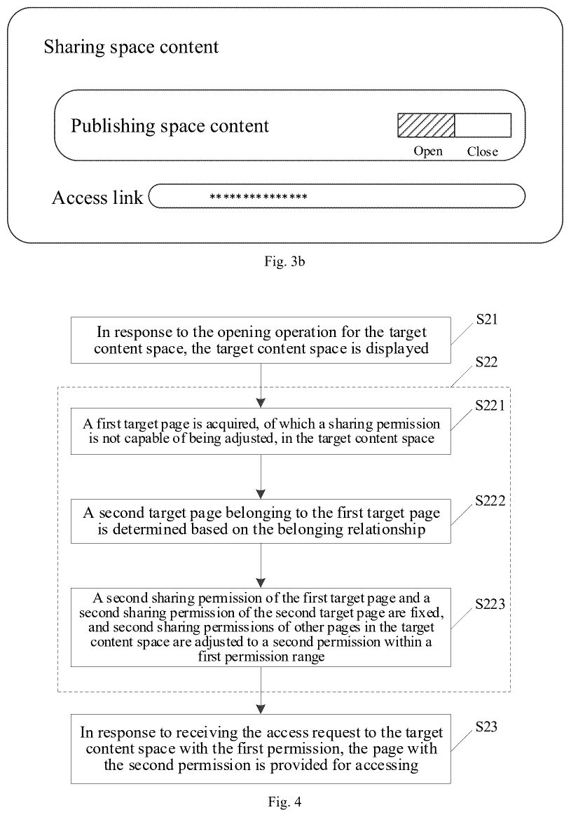

In some implementations, for example, FIG. 3a shows a sharing page of the target content space, and the state of the present target content space is not public. When the user interacts with the electronic device and selects the sharing switch, an interface shown in FIG. 3b is displayed. A copy link (unshown in FIG. 3b) is generated on the interface, herein the copy link is the sharing link mentioned above. Certainly, FIGS. 3a and 3b are only examples and do not limit the scope of protection of the present disclosure.

In some implementations, the user may trigger a corresponding electronic device to send an access request to the target content space with the first permission to the electronic device in this embodiment by interacting with the corresponding electronic device and clicking the sharing link. Correspondingly, in response to the request, the page with the second permission is provided for accessing. Since the sharing link is generated based on the target content space with the first permission and the page with the second permission, identity information of the user is carried in the access request, and the identity information of the user is compared with the second permission, thereby the corresponding page with the second permission is provided for the user to access.

The sharing method for the content space provided in this embodiment, when the target content space is shared, sets sharing permissions for the target content space and the pages in the target content space separately, so that when the integral target content space is externally shared, the sharing permission may be set for each page in the target content space separately: at the same time, when the sharing permission is set on the page, it is based on the belonging relationship of the page, the sharing permission of the father page may affect the sharing permission of the child page, thereby the data processing volume of adjusting the second sharing permission of the page is reduced, and the efficiency of content space sharing is improved.

In this embodiment, a sharing method for a content space is provided, and it may be used for the above electronic device, such as a user terminal or a server. FIG. 4 is a flow diagram of a sharing method for a content space according to an embodiment of the present disclosure, and as shown in FIG. 4, the flow includes the following steps:

S21, in response to the opening operation for the target content space, the target content space is displayed.

In some implementation modes, the target content space includes at least one page with the belonging relationship.

Please refer to S11 of the embodiment shown in FIG. 1 for details, it is not repeatedly described here.

S22, in response to changing the first sharing permission of the target content space to the first permission, the second sharing permission of the page is adjusted to the second permission based on the belonging relationship and the first permission.

In some implementations, the above S22 includes:

S221, a first target page is acquired, of which a sharing permission is not capable of being adjusted, in the target content space.

In response to the opening operation for the target content space, its first sharing permission is adjusted to the first permission.

In some implementations, after the first sharing permission is adjusted to the first permission, the first target page of which the sharing permission is non-adjustable is acquired by analyzing the page in the target content space. After the page is generated in the target content space, the user may set a permission attribute of each page. For example, the permission attribute is set as non-adjustable, this is equivalent that the page is a locked page.

In some implementations, the above S221 includes:
(1) A permission attribute of the page in the target content space is acquired.
(2) When the permission attribute of the page is non-adjustable, the page is determined as the first target page.

The permission attribute of the page in the target content space is acquired, and the permission attribute is analyzed. When its permission attribute is non-adjustable, the page is the first target page. When the target content space is constructed, its permission attribute may be set separately for each document. If the sharing permission of the document does not want to be adjusted subsequently during the permission extension, its permission attribute may be set as non-adjustable. The use of the permission attribute to represent a setting permission of the page guarantees the reliability of the first target page determined.

S222, a second target page belonging to the first target page is determined based on the belonging relationship.

In some implementation modes, after the first target page is determined in the target content space, according to the belonging relationship between the pages, a child page related to the first target page is queried, namely the second target page is acquired. In this embodiment, if it is determined that the permission of the first target page is non-adjustable, correspondingly it is considered that the permission of its child page is also non-adjustable.

In some implementations, the target content space is stored in the form of a multiway tree. Based on this, the above S223 includes:
(1) A node of the first target page in the multiway tree is used as a father node, and a child node belonging to the same branch as the father node is queried based on the relationship between the nodes.
(2) A page corresponding to the child node is determined as the second target page.

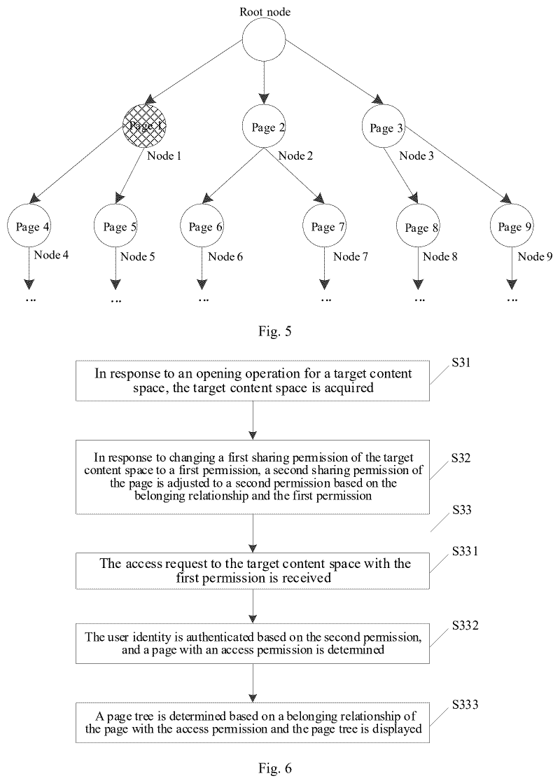

In some implementation modes, as shown in FIG. 5, the node in which the first target page is located is the node 1, the node 1 is determined as the father node, and the multiway tree is traversed, to query the child node belonging to the same branch as the node 1, namely the node 4 and the node 5. On this basis, the pages corresponding to the node 4 and the node 5, the page 4 and the page 5, are determined as the second target page.

In some implementation modes, when the permission extension is performed, the multiway tree is traversed, when it is found that the permission attribute of the page 1 is non-adjustable, namely the page 1 is a locked page, the sharing permission of the page 1 may not be modified at this time. At the same time, the child page of the page 1, namely the page 4 and the page 5, does not perform the permission extension. Therefore, this mechanism may guarantee the association of the sharing permissions between the page 1 and its child page. When the public page is displayed subsequently, since the sharing permissions of the page and its child page are associated, a page tree may be displayed on the interface, and the page tree is used to represent the belonging relationship of the page.

In some implementation modes, the target content space is stored in the form of the multiway tree, which may simplify subsequent query steps and improve the query efficiency of the second target page.

S223, a second sharing permission of the first target page and a second sharing permission of the second target page are fixed, and second sharing permissions of other pages in the target content space are adjusted to a second permission within a first permission range.

In some implementations, the first permission range is the same as the permission range of the first permission.

In some implementations, based on the above analysis, it is determined that the permissions of the first target page and the second target page are non-adjustable. Therefore, during the permission extension, the second sharing permission of the first target page and the second sharing permission of the second target page are fixed, and the second sharing permissions of other pages in the target content space are adjusted. When it is adjusted, the second sharing permissions of other pages may be adjusted to the second permission within the first permission range. for example, people on the Internet who gets the sharing link can read. By the above processing, the second permission after adjusting the second sharing permission for each page may be acquired. Furthermore, in the permission attribute of the page, the permission may also be set when the page is not public. For example, when the page is not public, the permission of the page is people within the organization who acquire the link can read, people within the organization who acquire the link can edit, It should be noted that the fixing the second sharing permission of the first target page and the second sharing permission of the second target page here refers to the fact that when the integral target content space is externally shared, the second permissions of the first target page and the second target page are not affected by the first permission; and it does not mean that the second sharing permissions are not adjusted, when the a second sharing permission of the first target page and the second sharing permission of the second target page are adjusted, it is adjusted to a preset permission defined in the permission attribute, namely the sharing permission under open defined in the permission attribute.

In some implementations, for the first target page and the second target page, when the integral target content space is externally shared, its second sharing permission is a preset sharing permission, and the sharing permission is non-adjustable during the permission extension. After an adjustment operation in this step, for the page, its second permission includes the second permission within the first permission range and the second permission within a second permission range, herein the first permission range is the same as the permission range of the first permission, and the second permission range is different from the permission range of the first permission.

In some optional implementations, for the page, the second permission may include the second permission within the first permission range, or the second permission within the second permission range, or include both the second permission within the first permission range and the second permission within the second permission range. Herein, the link is an access link to the target content space with the first permission.

In some implementations, the above S223 includes:
(1) The root node is used as a starting point, and it is judged whether the page corresponding to the node of the multiway tree is the first target page.
(2) When the page corresponding to the node of the multiway tree is the first target page, the sharing permission of the first target page and the sharing permission of the second target page are fixed.
(3) When the page corresponding to the node of the multiway tree is not the first target page, the sharing permission of the page corresponding to the node is adjusted.

In some implementations, when the permission extension is performed, the root node is used as the starting point, to sequentially judge whether the page corresponding to each node is the first target page. As mentioned above, the permission attribute of each page may be determined in advance, and the first target page and the second target page are determined firstly; or the first target page and the second target page are determined during the permission extension.

In some implementations, the second situation is taken as an example, it is started from the root node, and the permission attribute of the page corresponding to each node is analyzed sequentially. If the permission attribute is non-adjustable, the page is determined as the first target page, and based on the belonging relationship, the second target page belonging to the first target page is determined. At this time, the second sharing permission of the first target page and the second sharing permission of the second target page are fixed. If the permission attribute is not non-adjustable, the permission extension is performed on the page corresponding to the node, and the second sharing permission is adjusted to the second permission that is the same as the permission range of the first permission.

In some implementations, the first target page is queried based on the multiway tree, and since the relationship between the nodes in the multiway tree may represent the belonging relationship between the pages, the search efficiency of the first target page may be improved by using the node connection relationship of the multiway tree.

In some implementation modes, the above S22 includes:
(1) A first permission data and second permission data are acquired, the first permission data is used to store the first sharing permission of the content space, and the second permission data is used to store the second sharing permission of the page.
(2) Based on an identifier of the target content space, the first sharing permission of the target content space in the first permission data is adjusted to the first permission.
(3) Based on the belonging relationship and the first permission, the second sharing permission of the corresponding page in the second permission data is adjusted to the second permission.

In some implementations, two independent storage spaces are maintained, one is used to store the first sharing permission of the target content space, and the other is used to store the second sharing permission of the page. The sharing permissions of the target content space and the page are stored by the independent storage spaces, which may achieve physical isolation between the two, and enable the target content space to set the permission independently of the page. The first permission data is used to store the sharing permission of the content space, and the second permission data is used to store the sharing permission of the page. The presentation form of the first permission data and the second permission data includes but not limited to a database, a data table and the like. In this embodiment, the data table is taken as an example, correspondingly, the first permission data is a content space permission data table, the second permission data is a page permission data table, and each table only needs to store its own business data, to achieve the physical isolation without affecting each other. For example, the page permission may be set separately, because the modified data is from the page permission data table and is not constrained by the data in the content space permission data table. Namely, the different storage spaces are used to store the sharing permissions of the content space and the page respectively. Since the sharing permissions of a plurality of the content spaces are stored in the first permission data, it is necessary to firstly use the identifier of the target content space to determine the sharing permission of the target content space in the first permission data, and then set it as a public identifier. On this basis, combined with the belonging relationship of the page, the second sharing permission of the corresponding page is adjusted in the second permission data, to obtain the second permission of the page. Please refer to the above for the specific adjustment process. The sharing permissions of the content space and the page are stored separately by using the first permission data and the second permission data, and the two permission data are independent of each other, to achieve the physical isolation without affecting each other, thus the sharing permissions capable of setting the document separately are guaranteed.

In other implementation modes, Step (3) of the above S22 includes:
3.1) An external sharing field of the page corresponding to the node in the second permission data is set as an opening identifier, and the second permission data is used to store the sharing permission of the page.
3.2) A link sharing field of the page corresponding to the node in the second permission data is set as a sharing identifier of the second permission.

In some implementations, when the second sharing permission of the page corresponding to the node is adjusted, the page corresponding to the node is firstly located in the second permission data, and then the external sharing field of the page corresponding to the node is set as the opening identifier, and the link sharing field is set based on a public access permission of the page, it is set as the sharing identifier corresponding to the public access permission. In regard to the permission attribute of the public access permission, as mentioned above, when the content space is constructed, the public access permission and the non-public access permission may be set separately for the page. Therefore, when the page is public, the sharing permission may be set based on the public access permission.

In some implementations, when the external sharing field is set to 0, it represents that the field is not set; when the external sharing field is set to 1, it represents the opening identifier; when the external sharing field is set to 2, it represents the closing identifier. When the link sharing field is set to 0, it represents that the field is not set; when the link sharing field is set to 1, it represents that link sharing is closed; when the link sharing field is set to 2, it represents a person who obtain a link in an organization is capable of reading; when the link sharing field is set to 3, it represents a person who obtain a link in an organization is capable of editing; when the link sharing field is set to 4, it represents a person who obtain a link on the Internet is capable of reading; and when the link sharing field is set to 5, it represents a person who obtain a link on the Internet is capable of editing. Based on this, when the external sharing field and the link sharing field are set, it may be set to the corresponding specific value.

In some implementation modes, by setting the external sharing field and the link sharing field in the second permission data, the adjustment for the second sharing permissions of other pages is achieved, and when the link sharing field is set, it is also necessary to combine the public access permission of the page, as to guarantee the reliability of page sharing.

In some implementations, when the user interacts with the electronic device to operate an integral external sharing switch of the target content space, the first sharing permission of the target content space may be changed to the first permission, and an asynchronous task may be initiated to adjust the second sharing permission based on the belonging relationship, thereby the second permission of the page is acquired. For example, when the integral external sharing of the target content space is opened, the external sharing field of the target content space is changed to 1, it represents that the integral external sharing switch of the target content space is in an open state; and the asynchronous task is initiated to perform the permission extension on the page in the target content space, since the data structure of the target content space is the multiway tree, it is equivalent to adjusting the second sharing permission of the page by traversing the multiway tree, namely, the second sharing permission of the first target page and the second sharing permission of the second target page are fixed, and the second sharing permissions of other pages are adjusted to the second permission within the first permission range. For example, if the external sharing field of other pages is set to 1 and the link sharing field is set to 4, it represents that the external sharing switch of the document is in the open state, and the link sharing is set to be that a person who obtain a link on the Internet is capable of reading.

In some implementation modes, in the process of traversing the multiway tree, if the page is the locked page, it represents that the page may not be affected by the permission extension asynchronous task, thereby the independence of page permissions is guaranteed. When the integral target content space is shared externally, the external sharing field in the content space permission data table is modified; and then, the multiway tree is traversed by the permission extension asynchronous task, and the external sharing field and the link sharing field in the page permission data table are modified. When it is traversed by the permission extension asynchronous task, if the page is found to be the locked page, the field data of the page in the page permission data table may not be modified, and the child page of the page may no longer perform the permission extension.

S23, in response to receiving the access request to the target content space with the first permission, the page with the second permission is provided for accessing.

Please refer to S13 of the embodiment shown in FIG. 1 for details, it is not repeatedly described here.

The sharing method for the content space provided in this embodiment, for the first target page of which the sharing permission may not be adjusted, uses the belonging relationship to determine the second target page belonging to the first target page. Correspondingly, the sharing permission of the second target page may also not be adjusted. Even if the first sharing permission is public, the sharing permission of the first target page may not be adjusted, as to guarantee the flexible control of the sharing permission of the page.

In some implementation modes, the sharing method for the content space further includes:
(1) In response to a closing operation for the target content space.
(2) The first sharing permission is adjusted to a third permission, and the second sharing permission of the page is adjusted to a fourth permission based on the third permission and the belonging relationship.

In some implementation modes, the content space user may also close the sharing of the target content space by interacting with the electronic device. The user closes the sharing on the sharing interface, and in response to this operation, the first sharing permission of the target content space is adjusted to the third permission, namely the sharing is closed. The adjustment for the first sharing permission is to set the external sharing field of the target content space in the first permission data. If the external sharing field is 0, it represents that it is closed, and if the external sharing field is 1, it represents that it is opened. Therefore, the external sharing field of the target content space in the first permission data is set to 0.

In some implementations, after the setting of the first sharing permission is completed, the second sharing permission of the page is adjusted to the fourth permission, namely the non-public access permission, based on the belonging relationship of the page. Herein, the specific processing process of closing the sharing is similar to the processing process of opening the sharing mentioned above, as detailed in the previous text.

In some implementations, when the integral external sharing of the content space is closed, the external sharing field of the target content space is set to 2, it indicates that the integral external sharing switch of the target content space is in the close state; and the asynchronous task is initiated to perform the permission extension on the page, since the data structure of the target content space is the multiway tree, the page sharing permission is changed by traversing the multiway tree. The external sharing field is set to 2, it indicates that the external sharing switch of the page is in the open state, but it only a person who obtain a link on the Internet is capable of reading. After the target content space is closed, the second sharing permission of the page is adjusted accordingly, to guarantee the reliability of the page in the target content space.

In this embodiment, a sharing method for a content space is provided, and it may be used for the above electronic device, such as the user terminal or the server. FIG. 6 is a flow diagram of a sharing method for a content space according to an embodiment of the present disclosure, as shown in FIG. 6, the flow includes the following steps:

S31, in response to an opening operation for a target content space, the target content space is acquired.

Herein, the target content space includes at least one page with an belonging relationship.

Please refer to S21 of the embodiment shown in FIG. 4 for details, it is not repeatedly described here.

S32, in response to changing a first sharing permission of the target content space to a first permission, a second sharing permission of the page is adjusted to a second permission based on the belonging relationship and the first permission.

Please refer to S22 of the embodiment shown in FIG. 4 for details, it is not repeatedly described here.

S33, in response to receiving an access request to the target content space with the first permission, the page with the second permission is provided for accessing.

In some implementation modes, the above S33 includes:

S331, the access request to the target content space with the first permission is received.

In some implementations, a user identity is carried in the access request.

In some implementations, after the target content space is shared, a sharing link is generated, and the user may access the target content space by using the sharing link. The user sends the access request to the target content space by interacting with the sharing link. The user identity is carried in the access request, and the user identity includes whether the present visiting user is a user in the organization, whether the present visiting user is a visitor, and the like. The different user identities have different access permissions for the page in the target content space.

In some implementations, when the user clicks on the sharing link, it is skipped to the display page of the target content space by the sharing link. Herein, the user identity is acquired when skipped, and correspondingly, the user identity may be carried when the access request is sent.

S332, the user identity is authenticated based on the second permission, and a page with an access permission is determined.

In some implementations, after the user identity is acquired, the user identity is authenticated by using the second sharing permission of the page, to determine which pages the user has the access permission. Namely, the page with the access permission is determined. As mentioned above, when the second sharing permission is determined, the access permissions of different users are already defined when the page is public, for example, human-readable of acquiring the link in the organization, or human-readable of acquiring the link on the internet. The page with access permission is determined by querying the second sharing permissions of each page in the target content space.

S333, a page tree is determined based on a belonging relationship of the page with the access permission and the page tree is displayed.

In some implementation modes, due to the belonging relationship between the pages, after the page with the access permission is determined, the page tree is determined by using the belonging relationship, namely the belonging relationship between the pages with the access permissions. Correspondingly, the page tree may be displayed at a terminal that sends the access request.

In some implementations, the above S333 includes: the page tree is determined based on the belonging relationship of the page with the access permission, and the page tree is displayed in a page tree display area of a display interface. Herein the display interface further includes a page display area for displaying a page selected in the page tree display area. The display interface of the terminal that sends the access request includes the page tree display area and the page display area, the page tree display area displays the belonging relationship of the page with the access permission, and the page display area is used to display the specific content of the page.

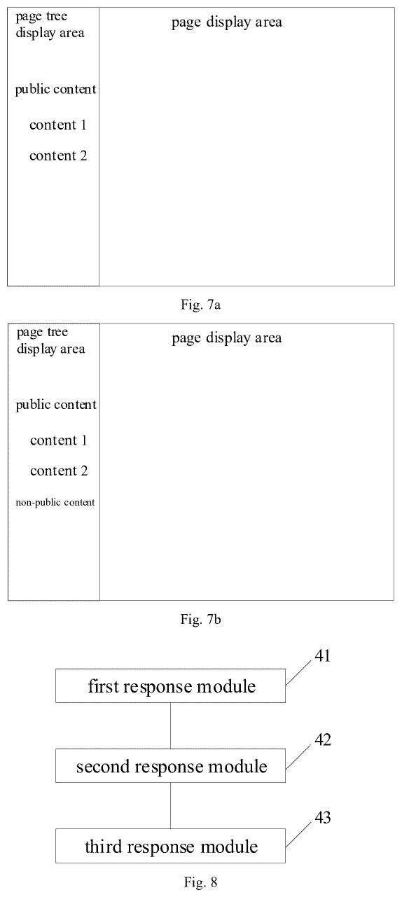

In some implementation modes, FIGS. 7a and 7b show display interfaces corresponding to access requests of different user identities. Herein, FIG. 7a shows the display interface corresponding to an anonymous user or a visitor, and FIG. 7b shows the display page corresponding to a member in an organization. By comparing FIGS. 7a and 7b, it may be seen that only the member in the organization may access the non-public content in the target content space, while the anonymous user or the visitor may only access the public content in the target content space.

In some implementations, it is also possible to access only the target page in the target content space, namely when the target content space is shared, only the sharing link of the target page is generated. The user may send the access request to the target document by clicking on the sharing link. When the visitor visits the page link, not only the user and the target page may be authenticated, but also the father node page of the target page may be queried upwards, to judge whether the user has a reading permission for the father node page. If the user has the reading permission for the father node page, it is rendered and displayed; and if the user does not have the reading permission for the father node page, it is not rendered and displayed, and continuously authenticated until the root node. This mode may allow the father node page with the access permission to be also displayed to the user when the target page of the content space is accessed, as to guarantee the association of the pages in the content space accessed by the user. At the same time, both the father node page and the target page may be displayed to the user by using the form of the page tree, to achieve the display of the page free tree.

The sharing method for the content space provided in this embodiment, after acquiring the access request, uses the second sharing permission to authenticate the user identity, determines the page with the access permission, and represents all pages with the access permission in the form of the page tree, it is convenient for user access.

As a specific application example of the embodiment of the present disclosure, an enterprise A needs to share the functional introduction of its product a with a user. Therefore, corresponding personnel of the enterprise A need to construct a content space for the product a, and the content space includes functions of the product a, usage methods, common troubleshooting, malfunction repair, and contact information of the corresponding research and development personnel of the product a and the like. Herein, the functions, the usage methods, the common troubleshooting and the like are all pages in the content space, herein the functions of the product a, the usage methods, the common troubleshooting, and the malfunction repair are the public pages, and the contact information of the corresponding research and development personnel of the product a is the non-public page. Therefore, when the content space is constructed, the permission attribute is set for each page. When the content space is shared externally, the second sharing permissions of the functions of the product a, the usage methods, the common troubleshooting, and the malfunction repair are human-readable of acquiring the sharing link on the internet, and the contact information of the corresponding research and development personnel of the product a is human-editable of acquiring the sharing link in the organization. Therefore, by setting the independent sharing permission for the page, it is possible to set the sharing permission for the page separately when the content space is shared.

In this embodiment, a sharing apparatus for a content space is further provided, the apparatus is used to implement the above embodiments and preferred implementation modes, those already described are not repeatedly described. As used below, the term “module” may be a combination of software and/or hardware that implements a predetermined function. Although the apparatus described in the following embodiments is preferably implemented by the software, the implementation of the hardware, or the combination of software and hardware, is also possible and envisioned.

This embodiment provides a sharing apparatus for a content space, as shown in FIG. 8, the sharing apparatus for the content space includes: a first response module 41, a second response module 42, and a third response module 43.

The first response module 41 is used to, in response to an opening operation for a target content space, display the target content space, herein the target content space includes at least one page with a belonging relationship.

The second response module 42 is used to, in response to changing a first sharing permission of the target content space to a first permission, and adjust a second sharing permission of the page to a second permission based on the belonging relationship and the first permission.

The third response module 43 is used to, in response to receiving an access request to the target content space with the first permission, provide the page with the second permission for accessing.

In some implementation modes, the second response module 42 includes: a first acquiring unit, a first determining unit, and a first adjusting unit.

The first acquiring unit is used to acquire a first target page in the target content space of which the sharing permission may not be adjusted.

The first determining unit is used to determine a second target page belonging to the first target page based on the belonging relationship.

The first adjusting unit is used to fix a second sharing permission of the first target page and a second sharing permission of the second target page, and adjust second sharing permissions of other pages in the target content space to a second permission within a first permission range, herein the first permission range is the same as the permission range of the first permission.

In some implementation modes, the first acquiring unit includes: a first acquiring subunit and a first determining subunit.

The first acquiring subunit is used to acquire a permission attribute of the page in the target content space.

The first determining subunit is used to, when the permission attribute of the page is non-adjustable, determine the page as the first target page.

In some implementation modes, the target content space is stored in the form of a multiway tree, a root node of the multiway tree is a root node of the target content space, a relationship between nodes of the multiway tree corresponds to the belonging relationship, and the first determining unit includes: a querying subunit and a second determining subunit.

The querying subunit is used to use the node of the first target page in the multiway tree as a father node, and query a child node belonging to the same branch as the father node based on the relationship between the nodes.

The second determining subunit is used to determine a page corresponding to the child node as the second target page.

In some implementations, the first adjusting unit includes: a judging subunit, a fixing subunit, and an adjusting subunit.

The judging subunit is used to use the root node as a starting point, and judge whether the page corresponding to the node of the multiway tree is the first target page.

The fixing subunit is used to, when the page corresponding to the node of the multiway tree is the first target page, fix the second sharing permission of the first target page and the second sharing permission of the second target page.

The adjusting subunit is used to, when the page corresponding to the node of the multiway tree is not the first target page, adjust the second sharing permission of the page corresponding to the node to the second permission within the first permission range.

In some implementation modes, the adjusting module 42 includes: a second acquiring unit, a second adjusting unit, and a third adjusting unit.

The second acquiring unit is used to acquire first permission data and second permission data, herein the first permission data is used to store the sharing permission of the content space, and the second permission data is used to store the sharing permission of the page.

The second adjusting unit is used to, based on an identifier of the target content space, adjust the sharing permission of the target content space in the first permission data to be public, and determine the first sharing permission to be public.

The third adjusting unit is used to, based on the belonging relationship and the first permission, adjust the second sharing permission of the corresponding page in the second permission data to the second permission.

In some implementation modes, the third adjusting unit includes: a first setting subunit and a second setting subunit.

The first setting subunit is used to set an external sharing field of the page corresponding to the node in the second permission data as an opening identifier.

The second setting subunit is used to set a link sharing field of the page corresponding to the node in the second permission data as a sharing identifier of the second permission.

In some implementation modes, the third response module 43 includes: an access request acquiring module, an authenticating module, and a determining module.

The access request acquiring module is used to receive an access request to the target content space with the first permission, herein a user identity is carried in the access request.

The authenticating module is used to authenticate the user identity based on the second permission, and determine a page with an access permission.

The determining module is used to determine a page tree based on a belonging relationship of the page with the access permission, and display the page tree.

In some implementation modes, the determining module includes: a second determining unit.

The second determining unit is used to determine the page tree based on the belonging relationship of the page with the access permission, and display the page tree in a page tree display area of a display interface, herein the display interface further includes a page display area that is used to display a page selected in the page tree display area.

In some implementation modes, the apparatus further includes: a close response module and a close adjusting module.

The close response module is used to respond a closing operation for the target content space.

The close adjusting module is used to adjust the first sharing permission to a third permission, and based on the third permission, adjust the second sharing permission of the page to a fourth permission.

The sharing apparatus for the content space in this embodiment is presented in the form of a functional unit, and the unit here refers to an application specific integrated circuit (ASIC), a processor and a memory that execute one or more software or fixed programs, and/or other devices that may provide the above functions.

The further functional descriptions of the above modules are the same as the corresponding embodiments mentioned above, and it is not repeatedly described here.

An embodiment of the present disclosure further provides an electronic device with the sharing apparatus for the content space shown in FIG. 8 above.

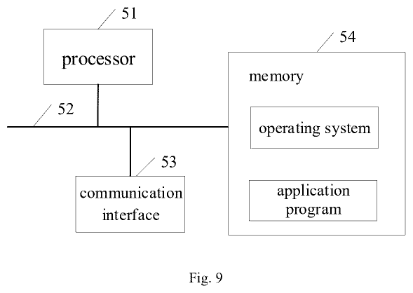

Please refer to FIG. 9, FIG. 9 is a structure schematic diagram of an electronic device provided in an optional embodiment of the present disclosure. As shown in FIG. 9, the electronic device may include: at least one processor 51, such as a central processing unit (CPU), at least one communication interface 53, a memory 54, and at least one communication bus 52. Herein, the communication bus 52 is used to implement connection communication between these components. Herein, the communication interface 53 may include a display and a keyboard, and optionally, the communication interface 53 may also include a standard wired interface and a wireless interface. The memory 54 may be a high-speed volatile random-access memory (RAM), or may be a non-volatile memory, such as at least one disk memory. Optionally, the memory 54 may also be at least one storage apparatus located far away from the aforementioned processor 51. Herein, the processor 51 may be combined with the apparatus described in FIG. 8, an application program is stored in the memory 54, and the processor 51 calls a program code stored in the memory 54 for executing the steps in any one of the above methods.

Herein, the communication bus 52 may be a peripheral component interconnect (PCI) bus or an extended industry standard architecture (EISA) bus or the like. The communication bus 52 may be divided into an address bus, a data bus, a control bus and the like. For case of representation, only one thick line is used in FIG. 9, but it does not mean that there is only one bus or one type of the bus.

Herein, the memory 54 may include a volatile memory, such as RAM; the memory may also include a non-volatile memory, such as a flash memory, a hard disk drive (HDD), or a solid-state drive (SSD); and the memory 54 may also include a combination of the above types of the memories.

Herein, the processor 51 may be CPU, a network processor (NP), or a combination of CPU and NP.

Herein, the processor 51 may further include a hardware chip. The above hardware chip may be ASIC, a programmable logic device (PLD), or a combination thereof. The above PLD may be a complex programmable logic device (CPLD), a field-programmable gate array (FPGA), a generic array logic (GAL), or any combinations thereof.

Optionally, the memory 54 is also used to store a program instruction. The processor 51 may call the program instruction to implement the sharing method for the content space shown in any one of the embodiments of the present application.

An embodiment of the present disclosure further provides a non-transient computer storage medium, the computer storage medium stores a computer executable instruction, and the computer executable instruction may execute the sharing method for the content space in any one of the above method embodiments. Herein, the storage medium may be a magnetic disk, an optical disk, a read-only memory (ROM), RAM, a flash memory, HDD or SSD or the like; and the storage medium may also include a combination of the above types of the memories.

The various embodiments in this description are all described in a progressive manner, and the same and similar parts between the various embodiments may be referred to each other. The emphasized descriptions of each embodiment are all the differences from other embodiments. Especially for a system embodiment, since it is basically similar to the method embodiment, the description is relatively simple, and the related parts refer to the description in the section of the method embodiment.

It may be understood that in the specific implementation modes of the present disclosure, related data such as the user information and the content space are involved. When the above embodiments of the present disclosure are applied to specific products or technologies, user permissions or consents are required, and the collection, use, and processing of the related data must comply with relevant laws, regulations, and standards of relevant countries and regions.

Although the embodiments of the present disclosure are described in combination with the drawings, those skilled in the art may make various modifications and variations without departing from the spirit and scope of the present disclosure, these modifications and variations all fall within the scope defined by the appended claims.

1. A sharing method for a content space, comprising:
in response to an opening operation for a target content space, displaying the target content space, wherein the target content space comprises at least one page with a belonging relationship;
in response to changing a first sharing permission of the target content space to a first permission, adjusting a second sharing permission of the page to a second permission based on the belonging relationship and the first permission; and
in response to receiving an access request to the target content space with the first permission, providing the page with the second permission for accessing.

2. The sharing method according to claim 1, wherein the adjusting a second sharing permission of the page to a second permission based on the belonging relationship and the first permission, comprises:
acquiring a first target page, of which a sharing permission is not capable of being adjusted, in the target content space;
determining a second target page belonging to the first target page based on the belonging relationship; and
fixing a second sharing permission of the first target page and a second sharing permission of the second target page, and adjusting second sharing permissions of other pages in the target content space to a second permission within a first permission range, wherein the first permission range is the same as a permission range of the first permission.

3. The sharing method according to claim 2, wherein the acquiring a first target page, of which a sharing permission is not capable of being adjusted, in the target content space, comprises:
acquiring a permission attribute of the page in the target content space; and
when the permission attribute of the page is non-adjustable, determining the page as the first target page.

4. The sharing method according to claim 2, wherein the target content space is stored in a form of a multiway tree, a root node of the multiway tree is a root node of the target content space, a relationship between nodes of the multiway tree corresponds to the belonging relationship, and the determining a second target page belonging to the first target page based on the belonging relationship, comprises:
using a node of the first target page in the multiway tree as a father node, and querying a child node belonging to a same branch as the father node based on the relationship between the nodes; and
determining a page corresponding to the child node as the second target page.

5. The sharing method according to claim 4, wherein the fixing a second sharing permission of the first target page and a second sharing permission of the second target page, and adjusting second sharing permissions of other pages in the target content space to a second permission within a first permission range, comprises:
using the root node as a starting point, and judging whether a page corresponding to a node of the multiway tree is the first target page;
when the page corresponding to the node of the multiway tree is the first target page, fixing the second sharing permission of the first target page and the second sharing permission of the second target page; and
when the page corresponding to the node of the multiway tree is not the first target page, adjusting the second sharing permission of the page corresponding to the node to the second permission within the first permission range.

6. The sharing method according to claim 1, wherein the in response to changing a first sharing permission of the target content space to a first permission, adjusting a second sharing permission of the page to a second permission based on the belonging relationship and the first permission, comprises:
acquiring first permission data and second permission data, wherein the first permission data is used to store the first sharing permission, and the second permission data is used to store the second sharing permission;
adjusting the first sharing permission of the target content space in the first permission data to the first permission based on an identifier of the target content space; and
adjusting the second sharing permission of a corresponding page in the second permission data to the second permission based on the belonging relationship and the first permission.

7. The sharing method according to claim 6, wherein the adjusting the second sharing permission of a corresponding page in the second permission data to the second permission based on the belonging relationship and the first permission, comprises:
setting an external sharing field of the page corresponding to the node in the second permission data as an opening identifier; and
setting a link sharing field of the page corresponding to the node in the second permission data as a sharing identifier of the second permission.

8. The sharing method according to claim 1, wherein the in response to receiving an access request to the target content space with the first permission, providing the page with the second permission for accessing, comprises:
receiving the access request to the target content space with the first permission, wherein the access request carries a user identity;
authenticating the user identity based on the second permission, and determining a page with an access permission; and
determining a page tree based on a belonging relationship of the page with the access permission to display the page tree.

9. The sharing method according to claim 8, wherein the determining a page tree based on a belonging relationship of the page with the access permission to display the page tree, comprises:
determining the page tree based on the belonging relationship of the page with the access permission to display the page tree in a page tree display area of a display interface, wherein the display interface further comprises a page display area, the page display area is used to display a page selected in the page tree display area.

10. The sharing method according to claim 1, further comprising:
in response to a closing operation for the target content space;
adjusting the first sharing permission to a third permission, and adjusting the second sharing permission of the page to a fourth permission based on the third permission and the belonging relationship.

11. The sharing method according to claim 1, wherein the second permission comprises at least one selected from a group consisting of: a first permission range that is the same as a permission range of the first permission, and a second permission range that is different from the permission range of the first permission.

12. The method according to claim 11, wherein the first permission comprises that a person who obtains a link on the Internet is capable of reading, the second permission comprises at least one selected from a group consisting of that a person who obtains a link in an organization is capable of reading, a person who obtains a link in an organization is capable of editing, a person who obtains a link on the Internet is capable of reading, or a person who obtains a link on the Internet is capable of editing, and the link is an access link to the target content space with the first permission.

13. (canceled)

14. An electronic device, comprising:
a memory and a processor, wherein the memory and the processor are connected to each other in communication, a computer instruction is stored in the memory, and the processor executes a sharing method for the content space, which comprises:
in response to an opening operation for a target content space, displaying the target content space, wherein the target content space comprises at least one page with a belonging relationship;
in response to changing a first sharing permission of the target content space to a first permission, adjusting a second sharing permission of the page to a second permission based on the belonging relationship and the first permission; and
in response to receiving an access request to the target content space with the first permission, providing the page with the second permission for accessing.

15. A non-transitory computer-readable storage medium, wherein the computer-readable storage medium stores a computer instruction, and the computer instruction is used to enable a computer to execute a sharing method for the content space, which comprises:
in response to an opening operation for a target content space, displaying the target content space, wherein the target content space comprises at least one page with a belonging relationship;
in response to changing a first sharing permission of the target content space to a first permission, adjusting a second sharing permission of the page to a second permission based on the belonging relationship and the first permission; and
in response to receiving an access request to the target content space with the first permission, providing the page with the second permission for accessing.

16. The electronic device according to claim 14, wherein the adjusting a second sharing permission of the page to a second permission based on the belonging relationship and the first permission, comprises:
acquiring a first target page, of which a sharing permission is not capable of being adjusted, in the target content space;
determining a second target page belonging to the first target page based on the belonging relationship; and
fixing a second sharing permission of the first target page and a second sharing permission of the second target page, and adjusting second sharing permissions of other pages in the target content space to a second permission within a first permission range, wherein the first permission range is the same as a permission range of the first permission.

17. The electronic device according to claim 16, wherein the acquiring a first target page, of which a sharing permission is not capable of being adjusted, in the target content space, comprises:
acquiring a permission attribute of the page in the target content space; and
when the permission attribute of the page is non-adjustable, determining the page as the first target page.

18. The electronic device according to claim 16, wherein the target content space is stored in a form of a multiway tree, a root node of the multiway tree is a root node of the target content space, a relationship between nodes of the multiway tree corresponds to the belonging relationship, and the determining a second target page belonging to the first target page based on the belonging relationship, comprises:
using a node of the first target page in the multiway tree as a father node, and querying a child node belonging to a same branch as the father node based on the relationship between the nodes; and
determining a page corresponding to the child node as the second target page.

19. The electronic device according to claim 18, wherein the fixing a second sharing permission of the first target page and a second sharing permission of the second target page, and adjusting second sharing permissions of other pages in the target content space to a second permission within a first permission range, comprises:
using the root node as a starting point, and judging whether a page corresponding to a node of the multiway tree is the first target page;
when the page corresponding to the node of the multiway tree is the first target page, fixing the second sharing permission of the first target page and the second sharing permission of the second target page; and
when the page corresponding to the node of the multiway tree is not the first target page, adjusting the second sharing permission of the page corresponding to the node to the second permission within the first permission range.

20. The electronic device according to claim 14, wherein the in response to changing a first sharing permission of the target content space to a first permission, adjusting a second sharing permission of the page to a second permission based on the belonging relationship and the first permission, comprises:
acquiring first permission data and second permission data, wherein the first permission data is used to store the first sharing permission, and the second permission data is used to store the second sharing permission;
adjusting the first sharing permission of the target content space in the first permission data to the first permission based on an identifier of the target content space; and
adjusting the second sharing permission of a corresponding page in the second permission data to the second permission based on the belonging relationship and the first permission.

21. The electronic device according to claim 20, wherein the adjusting the second sharing permission of a corresponding page in the second permission data to the second permission based on the belonging relationship and the first permission, comprises:
setting an external sharing field of the page corresponding to the node in the second permission data as an opening identifier; and
setting a link sharing field of the page corresponding to the node in the second permission data as a sharing identifier of the second permission.
